(19) United States
(12) Patent Application Publication
(10) Pub. No.: US 2025/0298141 A1
(43) Pub. Date: Sep. 25, 2025

(54) RADIO ALTIMETRY SYSTEM ABLE TO BE HOUSED ON BOARD AN AIRCRAFT

(71) Applicant: Airbus Operations (S.A.S.), Toulouse (FR)

(72) Inventors: Claude Pichavant, Toulouse (FR); Jean-luc Robin, Toulouse (FR); Olivier Pellay, Toulouse (FR)

(21) Appl. No.: 19/078,592

(22) Filed: Mar. 13, 2025

(30) Foreign Application Priority Data
Mar. 19, 2024 (FR) FR2402703

(51) Int. Cl. G01S 13/88; G01C 5/00

(52) U.S. Cl. CPC G01S 13/882; G01C 5/005

(57) ABSTRACT

A radio altimetry system to be housed on board an aircraft and provide an altitude of the aircraft above ground level, including a first subsystem based on FMCW technology and providing a first altitude value, a second subsystem based on UWB technology and providing a second altitude value, and consolidation electronic circuitry to compare the second value with a predetermined threshold, if the second value is less than or equal to the threshold, determine a consolidated value based on the first and second values, and if the second value is greater than the threshold, determine a consolidated value based on the first value and without taking into account the second value. In this way, the radio altimetry system offers resilience to various interference.

### TECHNICAL FIELD

The field of the disclosure herein is that of altimeters.

More precisely, the disclosure herein relates to a radio altimetry system able to be housed on board an aircraft and to provide an altitude of the aircraft above ground level.

Altitude above ground level is also called altitude AGL. It is generally measured in feet (a foot, the symbol for which is “ft”, for “foot” or “feet”, is equal to 0.3048 meters).

### BACKGROUND

Radio altimetry systems, also called “radio altimeters” or “radar altimeters”, are used in the field of civil or military aeronautics.

They are used in particular during automatic flight phases or critical flight phases, such as approach, landing (with in particular flare and roll-out operations) and take-off. In particular, the flare operation depends entirely on the radio altimeter.

The altitude above ground level (altitude AGL) measurement provided by a radio altimeter may be used for various functions implemented in an aircraft:
controlling the aircraft, in particular for (automatic or manual) landing and take-off operations;
impact protection without loss of control (or CFIT, for controlled flight into terrain);
increasing the awareness of the pilot through the cockpit screen;
activating a wind shear surveillance system, for example below 2300 ft (that is to say 701.04 m);
inhibiting dangerous maneuvers close to the ground;
generating alerts and warnings in the cockpit;
etc.

The prior art discloses various types of radio altimeters, the general principle of such instruments being that of measuring height by measuring the propagation time of radio signals transmitted and received after reflection from the ground.

In particular, the majority of civil aircraft use a radio altimeter based on a frequency-modulated continuous wave radar technology, referred to as FMCW radar technology. In the remainder of the description, such a radio altimeter is called an “FMCW radio altimeter”. In order to ensure safety and correct operation, it is common to house two or three FMCW radio altimeters on board the aircraft.

The FMCW radio altimeter uses the [4.2 GHz; 4.4 GHz] frequency band, which is itself contained within the C frequency band. The C band is of great interest for telecommunications, but it is therefore highly congested and prone to interference. As a result, frequency bands adjacent to the frequency band used by the FMCW radio altimeter are increasingly prone to interference. For this reason, the FMCW radio altimeter is potentially subject to external common-mode failures, caused by interference and resulting in operational restrictions (for example for low-visibility operations), and making the single pilot in operation (SPO) flying technique difficult to achieve.

The FMCW radio altimeter has the advantage of operating at a relatively high power, which offers a good level of resistance to interference, in particular low-power interference generated in a wide frequency band. However, it operates on a single band and is therefore sensitive to high-power interference localized on particular frequencies.

It is therefore desirable to provide a solution (radio altimetry system) that offers resilience to various interference, that is to say both to low-power interference generated in a wide frequency band and to high-power interference localized on particular frequencies.

Moreover, since the flare operation is triggered and performed below 100 ft AGL (that is to say 30.48 m above ground level), it is also desirable for the provided solution (radio altimetry system) to make it possible to reinforce the measurement at low altitude (for example below 100 ft AGL).

### SUMMARY

What is proposed here is a radio altimetry system able to be housed on board an aircraft and to provide an altitude of the aircraft above ground level, comprising:
a first subsystem based on a frequency-modulated continuous wave radar technology, referred to as FMCW radar technology, providing a first altitude of the aircraft above ground level value;
a second subsystem based on an ultra-wideband radar technology, referred to as UWB radar technology, providing a second altitude of the aircraft above ground level value; and
electronic circuitry, referred to as consolidation electronic circuitry, configured to:
compare the second altitude value with a predetermined altitude above ground level threshold;
if the second altitude value is less than or equal to the predetermined altitude above ground level threshold, determine a consolidated altitude of the aircraft above ground level value, on the basis of the first and second altitude values; and
if the second altitude value is greater than the predetermined altitude above ground level threshold, determine a consolidated altitude of the aircraft above ground level value, on the basis of the first altitude value and without taking into account the second altitude value.

The proposed radio altimetry system thus comprises two subsystems based on radar technologies that are distinct but complementary in terms of robustness against interference, namely a first subsystem (hereinafter called “FMCW subsystem”) based on FMCW radar technology and a second subsystem (hereinafter called “UWB subsystem”) based on UWB (ultra-wideband) radar technology. The proposed radio altimetry system furthermore comprises consolidation electronic circuitry that makes it possible to provide a consolidated altitude above ground level value based on the first and second altitude above ground level values provided by the FMCW subsystem and the UWB subsystem, respectively.

In this way, the proposed radio altimetry system offers resilience to various interference: low-power interference generated in a wide frequency band and high-power interference localized on particular frequencies. Indeed, as already mentioned above, the FMCW subsystem has the advantage of operating at a relatively high power and on a limited frequency band, thus making it possible to offer a good level of resistance to low-power interference generated in an ultra-wide frequency band. In a complementary manner, the UWB subsystem has the advantage of operating on an ultra-wide frequency band and at a relatively low power, thus making it possible to offer a good level of resistance to high-power interference localized on particular frequencies.

In addition, the UWB subsystem uses UWB pulses that introduce dissimilarity. These are very short (for example 2 ns) with a large bandwidth (for example 500 MHZ), such that they provide a level of accuracy similar to that of an FMCW subsystem and are therefore compatible with the flare operation.

The UWB frequency band used by the UWB subsystem is less than 10 GHz, meaning that it remains insensitive to heavy rain and attenuation due to fog. This is an important point for critical operations taking place in low-visibility conditions (heavy rain, fog).

In addition, the consolidation electronic circuitry guarantees that the second altitude value, provided by the UWB subsystem, is taken into account only if it is less than or equal to a predetermined altitude above ground level threshold. The proposed radio altimetry system thus makes it possible to reinforce the measurement at low altitude, that is to say below the predetermined altitude above ground level threshold.

It should be noted that the UWB subsystem has a very low power (for example limited to a maximum of −41.3 dBm/MHz), meaning that range is limited to a few tens of meters. However, this is sufficient for the flare operation, which begins between approximately 35 ft and 80 ft (50 ft on average), and also for the roll-out and take-off operations.

According to an embodiment, the first subsystem is configured to use a first frequency band, and the second subsystem is configured to use at least one second frequency band distinct from the first frequency band.

According to an embodiment, the first frequency band is the [4.2 GHz; 4.4 GHz] band and the second frequency band is contained within the [3.1 GHz; 10.6 GHz] band.

According to an embodiment, the second subsystem is configured to perform frequency hopping between at least two frequency bands distinct from the first frequency band.

According to an embodiment, the second subsystem is configured to use at least one pulse pattern that is distinct from a waveform used by the first subsystem.

According to an embodiment, the first and second subsystems share at least one element belonging to the group comprising an antenna and a coaxial cable.

According to an embodiment, the consolidation electronic circuitry is furthermore configured, in the event of a deviation between the first and second altitude values that is greater than a predetermined altitude deviation threshold, to select one of the first and second altitude values on the basis of at least one selection parameter, so as to form the consolidated value.

According to an embodiment, the at least one selection parameter belongs to the group comprising:
a barometric altitude provided by a barometric altimeter;
an inertial altitude provided by an inertial measurement unit; and
a stored altitude resulting from the storage of a previous consolidated value.

According to an embodiment, selecting one of the first and second altitude values on the basis of the at least one selection parameter comprises:
determining a reference altitude on the basis of the at least one selection parameter; and
selecting, from among the first and second altitude values, the altitude value closest to the reference altitude.

According to an embodiment, the predetermined altitude above ground level threshold is between 25 and 35 meters and, in an implementation, it is equal to 100 ft (that is to say 30.48 m).

What is also proposed here is an aircraft comprising the radio altimetry system presented above in any one of its embodiments.

### BRIEF DESCRIPTION OF THE DRAWINGS

The features of the disclosure herein that are mentioned above, and others, will become more clearly apparent from reading the following description of at least one example embodiment, the description being given in relation to the appended drawings, in which:

FIG. 1 schematically illustrates a side view of an aircraft equipped with a radio altimetry system;

FIG. 2 schematically illustrates the radio altimetry system, in an embodiment;

FIG. 3 schematically illustrates one example of a hardware architecture of the consolidation electronic circuitry contained within the radio altimetry system, in an embodiment; and

FIG. 4 schematically illustrates one example of a consolidation algorithm, executed by the consolidation electronic circuitry, in an embodiment.

### DETAILED DESCRIPTION

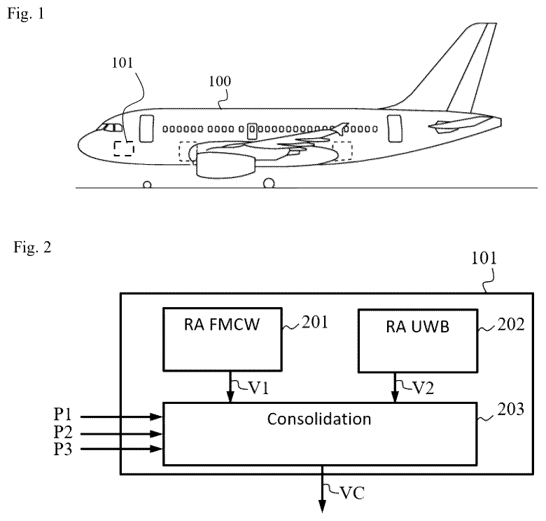

FIG. 1 schematically illustrates a side view of an aircraft 100 equipped with a radio altimetry system 101.

The radio altimetry system 101 is an item of on-board electronic equipment. For example, it forms part of electronic circuitry of the avionics of the aircraft 100. Its location in the aircraft may vary depending on aircraft models.

The radio altimetry system 101 is illustrated schematically in FIG. 2, in one embodiment in which it comprises a first radio altimetry subsystem 201, a second radio altimetry subsystem 202 and consolidation electronic circuitry 203.

The first subsystem 201, also called “FMCW subsystem” hereinafter (and denoted “RA FMCW” in FIG. 2), is based on a frequency-modulated continuous wave radar technology, referred to as FMCW radar technology. It provides a first altitude of the aircraft 100 above ground level value V1. The FMCW subsystem 201 is configured to use a first frequency band, which offers a first communication channel. In one embodiment, this is the [4.2 GHz; 4.4 GHz] band.

The second subsystem 202, also called “UWB subsystem” hereinafter (and denoted “RA UWB” in FIG. 2), is based on an ultra-wideband radar technology, referred to as UWB radar technology. It provides a second altitude of the aircraft 100 above ground level value V2. The UWB subsystem 202 is configured to use at least one second frequency band distinct from the first frequency band. In one embodiment, the UWB subsystem 202 is configured to perform frequency hopping between at least two frequency bands (each offering a different communication channel) distinct from the first frequency band. In one embodiment, the frequency bands between which the frequency hopping is performed are contained within the [3.1 GHZ; 10.6 GHz] band and each have a width equal to 500 MHZ. For example, the UWB subsystem 202 monitors interference received in these frequency bands and chooses the one with the least interference. In another example, the UWB subsystem 202 itself determines a frequency band of 500 MHz that is suitable (in terms of interference) within a permitted frequency range (for example [3.1 GHz; 10.6 GHz]).

The FMCW subsystem 201 and the UWB subsystem 202 thus use different frequency bands, and therefore complementary communication channels, thereby making it possible to achieve an appropriate level of robustness against all RF (radiofrequency) threats. This complementarity improves the availability and integrity of the data (altitude values) provided by the radio altimetry system. Indeed, as detailed hereinafter, if one of the first and second altitude values V1 and V2 is lost, the other may still be used, thereby increasing availability. If the two are inconsistent, an alert may be triggered, thereby increasing integrity.

In one embodiment, the UWB subsystem 202 is configured to use at least one pulse pattern that is distinct from a waveform used by the FMCW subsystem 201. The dissimilarity that is introduced (for example frequency hopping and/or code and/or timing) allows the radio altimetry system 101 to be more resilient against threats to data security and against multi-paths.

In one embodiment, the FMCW subsystem 201 and the UWB subsystem 202 share an antenna (for example a passive C-band microstrip patch antenna) and/or a coaxial cable. This makes it possible to reduce the implementation costs of the radio altimetry system 101.

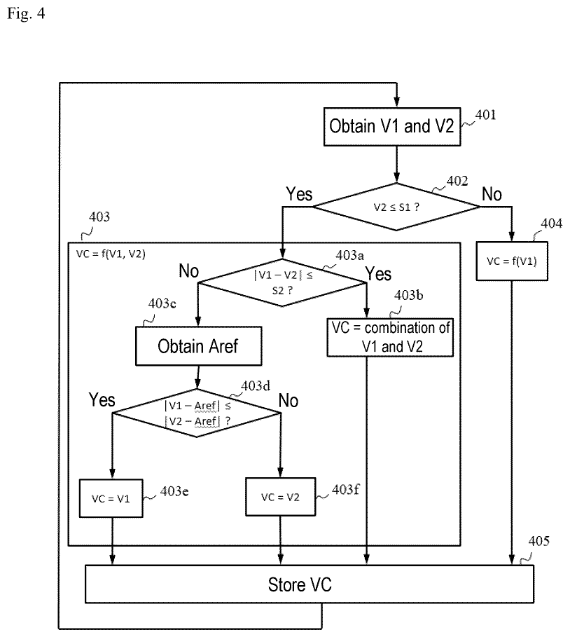

The consolidation electronic circuitry 203 receives the first and second altitude values V1 and V2 and generates, based thereon and on one or more selection parameters P1, P2 and P3 (see the description of FIG. 4 below), a consolidated altitude above ground level value VC.

FIG. 4 schematically illustrates one example of a consolidation algorithm, executed by the consolidation electronic circuitry 203, in one embodiment of the disclosure herein.

In a step 401, the consolidation electronic circuitry 203 obtains the first and second altitude values V1 and V2 generated by the FMCW subsystem 201 and the UWB subsystem 202, respectively.

In a step 402, the consolidation electronic circuitry 203 compares the second altitude value V2 with a first predetermined altitude above ground level threshold S1. For example, step 402 consists in carrying out the following test: “V2≤S1?”. In one embodiment, the first predetermined threshold S1 is between 25 and 35 meters. In an implementation, it is equal to 100 ft (that is to say 30.48 m).

If the second altitude value V2 is greater than the first predetermined threshold S1 (answer “no” to the test in step 402), the consolidation electronic circuitry 203 carries out step 404, in which it determines the consolidated altitude value VC on the basis of the first altitude value V1 and without taking into account the second altitude value V2 (VC=f (V1)). In an implementation of step 404, the consolidated altitude value VC is equal to the first altitude value V1. In other words, the second altitude value V2 is filtered when its value is greater than the first threshold S1 (for example 100 ft). Indeed, it is considered that UWB technology involves only low-energy signal pulses, which do not make it possible to measure altitudes above this first threshold. If the UWB subsystem 202 nevertheless provides a second altitude value V2 greater than the first threshold S1, it is assumed that this value V2 is probably not reliable.

If the second altitude value V2 is less than or equal to the first predetermined threshold S1 (answer “yes” to the test in step 402), the consolidation electronic circuitry 203 carries out step 403, in which it determines the consolidated altitude value VC on the basis of the first and second altitude values V1 and V2 (VC=f (V1, V2)).

At the end of step 403 or 404, the consolidation electronic circuitry 203 carries out step 405, in which it stores the consolidated altitude value VC, with a view to possibly using it in the following iteration of the consolidation algorithm that has just been described (return to step 401; for example, the consolidation electronic circuitry 203 obtains the first and second altitude values V1 and V2 every 50 ms).

In an implementation, illustrated in FIG. 4, step 403 itself comprises steps 403a to 403f.

In step 403a, the consolidation electronic circuitry 203 compares a deviation between the first and second altitude values V1 and V2 with a second predetermined altitude deviation threshold S2. For example, step 403a consists in carrying out the following test: “V1−V2|≤S2?”.

If the deviation between the first and second altitude values V1 and V2 is less than or equal to the second predetermined threshold S2 (answer “yes” to the test in step 403a, meaning that there is no significant difference between V1 and V2), the consolidation electronic circuitry 203 carries out step 403b, in which it determines the consolidated altitude value VC as a combination of the first and second altitude values V1 and V2. For example, VC is the average of V1 and V2. In one variant, VC is equal to V1. In another variant, VC is equal to V2.

If the deviation between the first and second altitude values V1 and V2 is greater than the second predetermined threshold S2 (answer “no” to the test in step 403a, meaning that there is a significant difference between V1 and V2), the consolidation electronic circuitry 203 carries out step 403c, in which it obtains a reference altitude Aref on the basis of one or more selection parameters, for example:
a barometric altitude (parameter P1 in FIG. 2) provided by a barometric altimeter;
an inertial altitude (parameter P2 in FIG. 2) provided by an inertial measurement unit; and
a stored altitude (parameter P3 in FIG. 2) resulting from the storage of a previous consolidated value VC.

In one implementation, the stored altitude (P3) is just used to initiate the inertial altitude (P2) and the barometric altitude (P1), which are relative altitudes and therefore have to proceed from a reference based on a true altitude (relative to the ground). This true altitude corresponds for example to the last time there was no significant difference between the two altitude values V1 and V2, that is to say to the stored altitude (P3).

At the end of step 403c, the consolidation electronic circuitry 203 carries out step 403d and one of steps 403e and 403f, thus making it possible to select (so as to form the consolidated value VC) that one of the first and second altitude values V1 and V2 that is closest to the reference altitude Aref. In this way, the use of one or more of the parameters P1, P2 and P3 makes it possible to aid discrimination and therefore improve the continuity of the radio altimetry system 101.

More precisely, in step 403d, the consolidation electronic circuitry 203 carries out the following test: “V1−Aref|≤|V2−Aref|?”.

If the first altitude value V1 is closest to the reference altitude Aref (answer “yes” to the test in step 403d), the consolidation electronic circuitry 203 chooses, in step 403e, the first altitude value V1 as consolidated value VC (VC=V1).

If the second altitude value V2 is closest to the reference altitude Aref (answer “no” to the test in step 403d), the consolidation electronic circuitry 203 chooses, in step 403f, the second altitude value V2 as consolidated value VC (VC=V2).

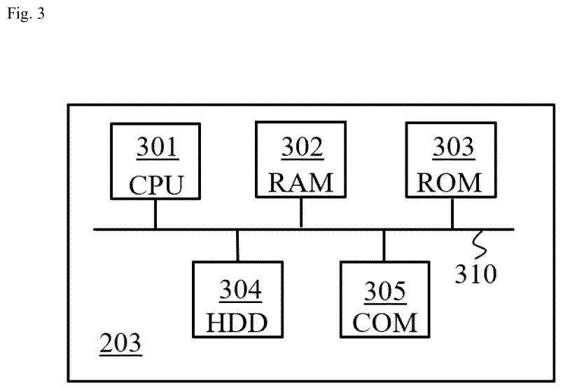

FIG. 3 schematically illustrates one example of a hardware architecture of the consolidation electronic circuitry 203 contained within the radio altimetry system 101. In this example, the consolidation electronic circuitry 203 then comprises the following, connected by a communication bus 310: a processor or CPU (central processing unit) 301; a random access memory RAM 302; a read-only memory ROM 303, for example a flash memory; a data storage device, such as an HDD (hard disk drive), or a storage medium reader, such as an SD (Secure Digital) card reader 304; at least one communication interface 305 allowing the consolidation electronic circuitry 203 to interact with the avionics of the aircraft 100.

The processor 301 is capable of executing instructions loaded into the RAM 302 from the ROM 303, from an external memory (not shown), from a storage medium such as an SD card, or from a communication network (not shown). When the consolidation electronic circuitry 203 is powered up, the processor 301 is capable of reading instructions from the RAM 302 and of executing them. These instructions form a computer program that causes the processor 301 to implement the behaviors, steps and algorithms described here.

All or some of the behaviors, steps and algorithms described here may thus be implemented in software form by executing a set of instructions using a programmable machine, such as a DSP (digital signal processor) or a microcontroller, or be implemented in hardware form by a machine or a dedicated component (chip) or a dedicated set of components (chipset), such as an FPGA (field-programmable gate array) or ASIC (application-specific integrated circuit). Generally speaking, the consolidation electronic circuitry 203 is designed and configured to implement the behaviors, steps and algorithms described here.

While at least one example embodiment of the invention(s) is disclosed herein, it should be understood that modifications, substitutions, and alternatives may be apparent to one of ordinary skill in the art and can be made without departing from the scope of this disclosure. This disclosure is intended to cover any adaptations or variations of the example embodiment(s). In addition, in this disclosure, the terms “comprise” or “comprising” do not exclude other elements or steps, the terms “a”, “an” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A radio altimetry system able to be housed on board an aircraft and to provide an altitude of the aircraft above ground level, comprising:
a first subsystem based on a frequency-modulated continuous wave (FMCW) radar technology, providing a first altitude of the aircraft above ground level value;
a second subsystem based on an ultra-wideband (UWB) radar technology, providing a second altitude of the aircraft above ground level value; and
consolidation electronic circuitry configured to:
compare the second altitude value with a predetermined altitude above ground level threshold;
if the second altitude value is less than or equal to the predetermined altitude above ground level threshold, determine a consolidated altitude of the aircraft above ground level value, based on the first and second altitude values; and
if the second altitude value is greater than the predetermined altitude above ground level threshold, determine a consolidated altitude of the aircraft above ground level value, based on the first altitude value and without taking into account the second altitude value.

2. The radio altimetry system of claim 1, wherein the first subsystem is configured to use a first frequency band, and wherein the second subsystem is configured to use at least one second frequency band distinct from the first frequency band.

3. The radio altimetry system of claim 2, wherein the first frequency band is a [4.2 GHz; 4.4 GHz] band and wherein the second frequency band is contained within a [3.1 GHz; 10.6 GHz] band.

4. The radio altimetry system of claim 2, wherein the second subsystem is configured to perform frequency hopping between at least two frequency bands distinct from the first frequency band.

5. The radio altimetry system of claim 1, wherein the second subsystem is configured to use at least one pulse pattern that is distinct from a waveform used by the first subsystem.

6. The radio altimetry system of claim 1, wherein the first and second radio subsystems share at least one element belonging to a group comprising an antenna and a coaxial cable.

7. The radio altimetry system of claim 1, wherein the consolidation electronic circuitry is further configured, in an event of a deviation between the first and second altitude values that is greater than a predetermined altitude deviation threshold, to select one of the first and second altitude values based on at least one selection parameter, so as to form the consolidated value.

8. The radio altimetry system of claim 7, wherein the at least one selection parameter belongs to a group comprising:
a barometric altitude provided by a barometric altimeter;
an inertial altitude provided by an inertial measurement unit; and
a stored altitude resulting from storage of a previous consolidated value.

9. The radio altimetry system of claim 7, wherein selecting one of the first and second altitude values based on the at least one selection parameter comprises:
determining a reference altitude based on the at least one selection parameter; and
selecting, from among the first and second altitude values, the altitude value closest to the reference altitude.

10. The radio altimetry system of claim 1, wherein the predetermined altitude above ground level threshold is between 25 and 35 meters.

11. An aircraft comprising the radio altimetry system of claim 1.
